(19) United States
(12) Patent Application Publication
(10) Pub. No.: US 2026/0188913 A1
(43) Pub. Date: Jul. 2, 2026

(54) WIDE FIELD OF VIEW ANTENNA FOR BLIND SPOT DETECTION

(71) Applicant: Sensata Technologies, Inc., Attleboro, MA (US)

(72) Inventors: Jonathan M. Rigelsford, Sheffield (GB); Bryan S. Holloway, Boise, ID (US)

(73) Assignee: Sensata Technologies, Inc., Attleboro, MA (US)

(21) Appl. No.: 18/827,015

(22) PCT Filed: Mar. 8, 2023
(86) PCT No.: PCT/US2023/014803

§ 371 Date: Sep. 6, 2024

Related U.S. Application Data
(60) Provisional application No. 63/318,296, filed on Mar. 9, 2022.

(51) Int. Cl. H01Q 21/06; G01S 13/931; H01Q 1/32

(52) U.S. Cl. CPC H01Q 21/065; G01S 13/931; H01Q 1/3233; G01S 2013/9315

(57) ABSTRACT

A radar system and methods of using the system provide a wide field of view for identifying objects proximate a vehicle. The radar system includes a number of aligned strings of patch antennas as a transmit antenna and one or more strings of patch antennas as a receiving antenna. Driving circuitry also is provided to drive transmission via the antenna strings. In examples, the antenna system reduces the negative impacts of deep nulls.

### CROSS-REFERENCE TO RELATED APPLICATIONS

This application claims the benefit of priority of International Patent Application No. PCT/US2023/014803, titled, “WIDE FIELD OF VIEW ANTENNA FOR BLIND SPOT DETECTION,” filed Mar. 8, 2023, which claims the benefit of priority of U.S. Provisional Application No. 63/318,296, titled “Wide Field of View Antenna for Blind Spot Detection,” and filed Mar. 9, 2022, the entire disclosures of which are hereby incorporated by reference.

### FIELD OF THE TECHNOLOGY

The subject disclosure relates to detecting objects proximate a vehicle, and more particularly to an improved antenna system for use in detecting objects in a vehicle blind spot.

### BACKGROUND OF TECHNOLOGY

Some vehicles, including heavy commercial vehicles and automobiles, incorporate blind spot information systems (BSIS) and/or moving off information systems (MOIS). Such systems are intended to aid a driver of the vehicle to detect (and therefore avoid) objects, such as pedestrians, cyclists, other vehicles, buildings, infrastructure, and/or the like, that may not be visible to the driver. For instance, these objects may be in a blind spot and/or in close proximity to a front or rear of the vehicle. Such systems improve driver awareness during moving off, turning, and lane change controls, and can improve safety in operation of autonomous vehicles

Some conventional systems for detecting objects proximate a vehicle use radar. For example, such systems include a transmitter that transmits radio waves into an area proximate a vehicle, e.g., an area associated with a “blind spot” of the vehicle. When an object is located proximate the vehicle, the emitted radio waves reflect off the object, and return to a receiver associated with the system. These conventional systems have a limited field of view which may be ineffective for use with larger vehicle. Other conventional systems are configured to detect objects at an angle, e.g., to improve or direct the field of view. However, such systems often have null spots, in which transmission of radio waves is limited, which can lead to decreased detection in those areas. This may be particularly problematic when a null spot aligns with a portion of the blind spot of the vehicle.

### SUMMARY OF THE TECHNOLOGY

The subject technology relates to improved object detection systems and methods of using such systems. For example, aspects of this disclosure relate to an improved antenna that provides improved object detection in BSISs and/or MOISs.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a top-view of an environment in which a vehicle with an equipped radar system is operating, in accordance with aspects of this disclosure.

FIG. 2 is a schematic diagram of a radar system, in accordance with aspects of this disclosure.

FIG. 3 is a perspective view of a wide field of view antenna, in accordance with aspects of this disclosure.

FIG. 4 is a graph showing an antenna array radiation pattern for the antenna of FIG. 3, in accordance with aspects of this disclosure.

FIG. 5 is a graph showing an antenna array radiation pattern for the antenna of FIG. 3 compared to a pattern for a conventional antenna array, in accordance with aspects of this disclosure.

FIG. 6 is a graph showing system level improvements in the detectability of an object using the antenna of FIG. 3, compared to conventional designs.

FIG. 7 is an example system diagram showing aspects of a radar system of a vehicle, such as a heavy commercial vehicle or an automobile, in accordance with aspects of this disclosure.

### DETAILED DESCRIPTION

The subject technology overcomes many of the prior art problems associated with sensor-based blind spot monitoring. In brief summary, the subject technology provides an improved antenna design and techniques for using the antenna design that result in improved detection of objects proximate vehicles.

More specifically, aspects of this disclosure relate to an improved radar system that includes a radar transmitter, a transmitting antenna, and a receiving antenna. In examples, the radar transmitter can include a Doppler radar transmitter configured to output radio waves. The radar system may be configured for use in the 76-81 GHz frequency range, although the system may be scaled to operate at other frequencies.

In aspects of this disclosure, the transmitting antenna may include a plurality of strings of patch antennas. As used herein, a string of patch antennas may be a plurality of patch antennas coupled to each other. For example, the patch antennas may be aligned generally linearly, e.g., generally along a linear axis. In at least some examples, the transmitting antenna includes at least three strings of patch antennas, with the strings arranged generally parallel. Additional strings of patch antennas may be provided, although it may be desirable in some implementations to have an odd number of strings of patch antennas, e.g., to avoid a null spot in a direction normal to the patch antennas (for example, perpendicular to a side of a vehicle using the radar system).

The radar transmitter may include a controller configured to control the transmission of radio waves via the transmitting antenna. In some aspects of this disclosure, adjacent strings of the patch antennas can be controlled to transmit in anti-phase. In other instances, adjacent strings may be configured to transmit at near anti-phase, e.g., within a threshold of anti-phase, but not exactly in anti-phase. Also in examples, the strings may be controlled to transmit at different amplitudes. For example, transmitting at near anti-phase and/or varying the amplitude may improve the array radiation pattern, e.g., by reducing deep nulls.

In aspects of this disclosure, the receiving antenna can include one or more strings of patch antennas. For example, the receiving antenna can include a single string of patch antennas. In examples in which multiple strings of patch antennas are used for the receiving antenna, the strings of patch antennas may be substantially parallel to each other.

According to aspects of this disclosure, in use, the radar system may be disposed on a vehicle such that the strings of patch antennas of the transmitting antenna and/or the strings of patch antennas of the receiving antenna are arranged substantially perpendicular to a horizontal (azimuthal) plane. The radar system may further be configured such that patch antennas are arranged in a substantially vertical plane, e.g., corresponding to a (vertical) side of the vehicle on which the radar system is mounted.

The advantages, and other features of the systems and methods disclosed herein, will become more readily apparent to those having ordinary skill in the art from the following detailed description of certain preferred embodiments taken in conjunction with the drawings which set forth representative examples of the present disclosure.

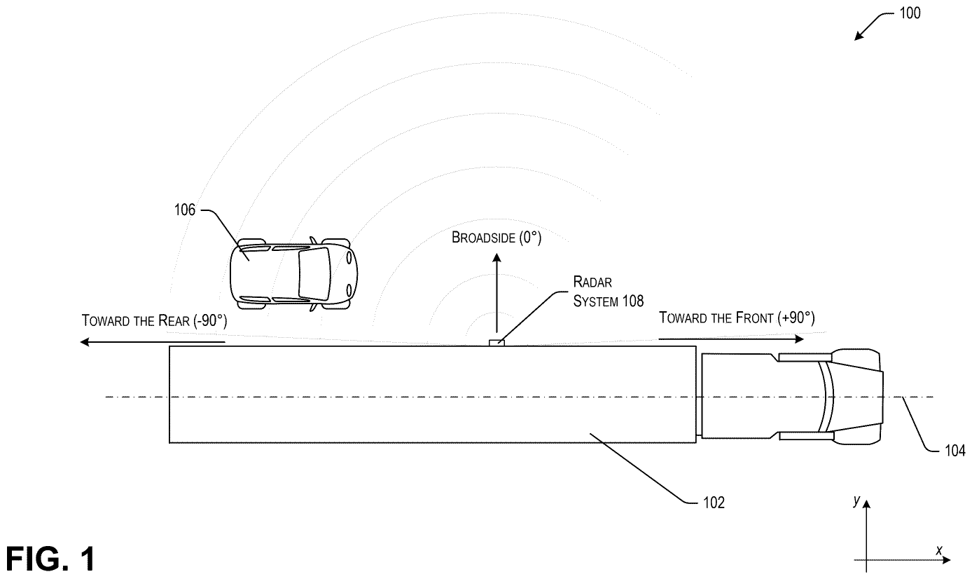

FIG. 1 is a top view representation of an environment 100. A vehicle 102 is travelling in the environment 100. In the example, the vehicle 102 is a heavy commercial vehicle, e.g., a tractor trailer. However, this disclosure is not limited to HCVs, as aspects described herein may be used in connection with passenger vehicles, autonomous vehicles, construction vehicles, and/or any other land-, sea-, or airborne vehicle in which it may be desirable to detect objects proximate thereto. In the illustrated example, the vehicle 102 has a length, e.g., from a leading end to a trailing end, along a longitudinal axis 104. The vehicle 102 also has a width in a lateral direction, e.g., perpendicular to the longitudinal axis 104. Reference axes provided in FIG. 1 show that the vehicle 102 is travelling generally in an x-direction, and the width of the vehicle 102 is in the y-direction. The x-y plane corresponds to an azimuthal plane.

As also illustrated in FIG. 1, a second vehicle 106 also is travelling in the environment 100. In the example, the second vehicle 106 is travelling generally in the x-direction, for instance to pass the vehicle 102. As will be appreciated, as the second vehicle 106 overtakes the vehicle 102, the second vehicle 106 may be in a blind spot of the vehicle 102 and/or may be otherwise difficult to perceive by an operator of the vehicle 102. Although the example of FIG. 1 uses the second vehicle 106 as an object that may be difficult for an operation or the vehicle 102 to perceive, this disclosure may be useful to detect any or all objects proximate the vehicle 102, e.g., whether or not the vehicle 102 is moving.

The vehicle 102 includes a radar system 108 configured to sense the second vehicle 106 (and/or other objects proximate the vehicle 102). FIG. 1 also provides a frame of reference for measurements about the vehicle 102. Specifically, a broadside direction, e.g., extending in the y-direction, perpendicular to the longitudinal axis 104 of the vehicle 102, corresponds to zero degrees (0°). A direction along the (positive) x-axis is plus-ninety degrees (+90°—labelled “toward the front”), and an opposite direction along the (negative) x-axis is minus-ninety degrees (−90°—labelled “toward the rear”). As shown in FIG. 1, the radar system 108 may have a field of view, shown generally by concentric circles, of substantially 180-degrees. Aspects of this disclosure may be useful to provide improvements of the field of view of the radar system in the azimuthal plane shown, e.g., relative to conventional radar systems.

In the example of FIG. 1, the radar system 108 is illustrated as being disposed proximate a longitudinal center of the vehicle. This position may be desirable at least because, as detailed further herein, the radar system 108 has improved sensing capability over the full 180-degrees, with limited adverse impacts from null spots. However, the radar system 108 may be placed relatively closer to the front of the vehicle 102 or relatively closer to the rear of the vehicle 102. In some examples, the radar system 108 may be disposed at a location to best correspond to a blind spot of the vehicle 102. Moreover, although the radar system 108 is illustrated as being disposed on the left (relative to the direction of travel) side of the vehicle 102, the radar system 108, or another instance of the radar system 108, may be disposed on the right side of the vehicle 102 and/or otherwise on the vehicle 102. In aspects of this disclosure, the construction of the radar system 108 may allow for the radar system 108 to be substantially symmetrical, e.g., such that a radiation pattern of the radar sensor has substantially the same power at the same angles from perpendicular (e.g., at 20° and −20°). Because of this symmetry, the same radar system 108 may be placed on either side of the vehicle, e.g., without the need for different designs for left-hand and right-hand drive vehicles. Moreover, the symmetry may obviate the need for recalibration, system-wide RF modelling, and/or the like, as required by many conventional systems.

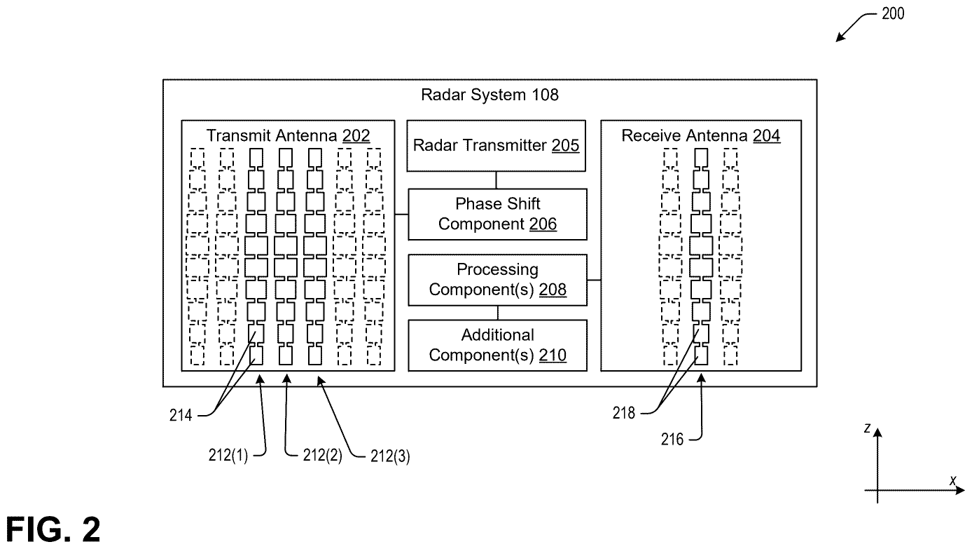

FIG. 2 is a schematic representation 200 of aspects of the radar system 108, according to examples of this disclosure. In FIG. 2, the radar system 108 is illustrated as including a plurality of modules or other logically-connected computing blocks and/or computer and/or electrical components. For instance, various of the illustrated blocks and/or other aspects of the radar system 108 may be implemented as circuitry and/or an intelligent hardware device, e.g., a central processing unit (CPU), a microcontroller, an application specific integrated circuit (ASIC), or may be implemented as part of a reconfigurable device. In at least some examples, the radar system 108 can include a circuit board, such as a printed circuit board (PCB) on which components of the radar system 108 are disposed and/or to which the components of the radar system 108 are otherwise coupled. Aspects of the radar system 108 can include random access memory (RAM) and read-only memory (ROM) which may include instructions that are configured to, when executed (or when compiled and executed), cause aspects of the radar sensor to perform various functions described herein. Various components of the radar system 108 may be implemented using one or more separate CPUs or ASICs, for example, and the components may, individually or collectively, be implemented with one or more ASICs adapted to perform some or all of the applicable functions in hardware. Each of the noted components may be a means for performing one or more functions related to operation of the system.

The radar system 108 is illustrated in FIG. 2 as including a transmit antenna 202, a receive antenna 204, a radar transmitter 205, a phase shift component 206, one or more processing components 208, and one or more additional components 210. Generally, the radar system 108 is configured to transmit radio waves, e.g., via the transmit antenna 202. When an object is present proximate the radar system 108, e.g., the second vehicle 106 in FIG. 1, the radio waves reflect off the object and are received at the receive antenna 204. The received radio waves are then processed to determine the presence of the object.

The transmit antenna 202 comprises a patch antenna. Specifically, the transmit antenna 202 is illustrated as including a first antenna element 212(1), a second antenna element 212(2), and a third antenna element 212(3) (collectively referred to herein as the antenna elements 212). Additional instances of the antenna elements also are shown (in broken lines), and may be included in some implementations. In the illustrated example, each of the antenna elements 212 comprises a string of connected patches 214, e.g., as patch antennas. In the example of FIG. 2, each of the strings of antenna elements 212 includes ten (10) patches, although more or fewer may be used. For instance, the total antenna array gain and/or the system range can be optimized by varying the number of the patches 214 along each string. For example, providing additional patches 214 along each string can reduce the elevation pattern beamwidth, and therefore increase the gain.

As illustrated, the antenna elements 212, e.g., the strings of patch antennas, are disposed vertically, e.g., such that all the patches 214 of one string extend generally in the z-direction. Adjacent instances of the antenna elements 212 extend generally parallel to each other, spaced in the x-direction. In examples of this disclosure, at least three instances of the antenna elements 212 may be provided. Although not required, it may also be desirable that an overall number of the antenna elements 212 of the transmit antenna 202 is an odd number. For example, and as shown further herein, the use of an odd number may prevent a null in the broadside direction. As shown, the generally planar patches 214 are generally disposed in the x-z plane. For simplicity and clarity, connections between the individual antenna elements 212 are not shown in FIG. 2.

The receive antenna 204 includes an antenna element 216. Additional instances of the antenna element 216 also are shown (in broken lines), and may be included in some implementations. In the illustrated example, the antenna element 216 includes a string of connected patches 218, e.g., as patch antennas. In the example of FIG. 2, like the antenna elements 212, the string of antenna elements 216 includes ten (10) patches, although more or fewer may be used. Also like the antenna elements 212, the antenna element 216 is arranged vertically, e.g., such that all the patches 218 of the string extend generally in the z-direction. Adjacent instances of the antenna element 216 (when used) extend generally parallel to each other, spaced in the x-direction. As shown, like the patches 214, the generally planar patches 218 are generally disposed in the x-z plane. For simplicity and clarity, connections associated with the antenna element 216 are not shown in FIG. 2.

Although the transmit antenna 202 is illustrated as including instances of the antenna elements 212 and the receive antenna 204 is illustrated as including one or more instances of the antenna elements 216, in some examples the same antenna elements may be used for transmission and reception. For example, one or more of the antenna elements 212 can be configured to receive radio waves.

The radar transmitter 205 is generally configured to generate or facilitate generation of electromagnetic waves for transmission by the transmit antenna 202. In examples, the radar transmitter 205 may be configured for use in the 76-81 GHz frequency range, although aspects of the system may be scaled to operate at other frequencies.

The phase shift component 206 is configured to adjust the phase of a signal (e.g., a feed signal from the radar transmitter 205) to each of the antenna elements 212 of the transmit antenna 202. Most conventional antenna designs provide maximum signal radiation or reception at boresight (perpendicular) to the plane of the antenna. This main beam or lobe can be squinted, tilted, or steered towards the front or rear of the vehicle by varying the relative phase difference between the elements. For instance, some conventional designs may direct the main beam or lobe toward the rear of the vehicle, e.g., at approximately −20-degrees in the illustration of FIG. 1, to better align the main beam or lobe with the blind spot. Applying a progressive phase shift vertically between the antenna elements will result in steering of the main beam in the vertical direction. Conversely, applying a progressive phase shift horizontally between the antenna elements will result in steering of the main beam in the horizontal direction.

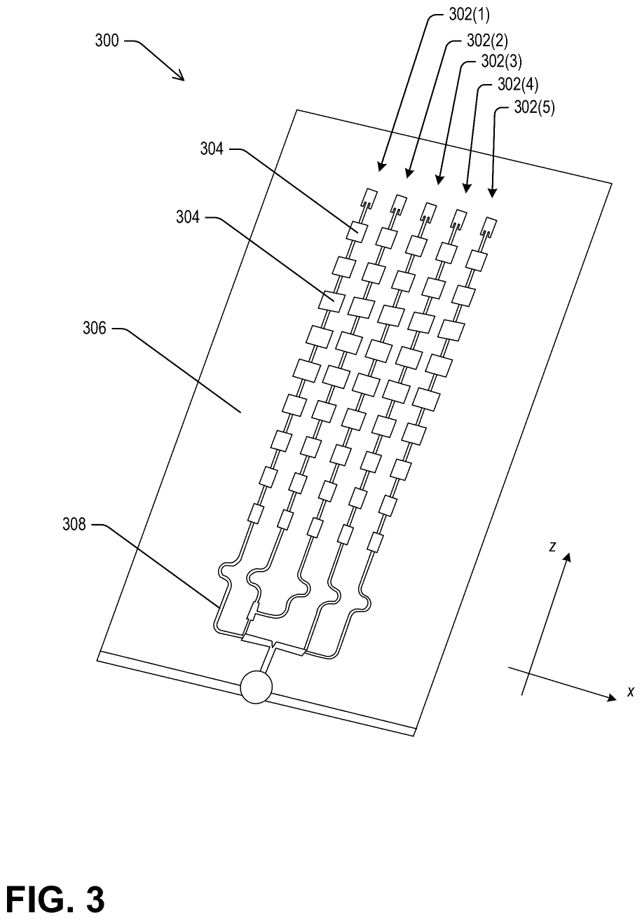

In examples of this disclosure, rather than applying an equal or progressive phase shift in the azimuthal direction, the phase shift component 206 can include functionality to feed the antenna elements 212 (e.g., the strings) in anti-phase (180° phase shift between adjacent strings). In still further examples, the phase shift component 206 can include functionality to feed the antenna elements 212 in near anti-phase, e.g., within a threshold of a 180° phase shift. For example, in some examples, adjacent antenna elements 212 may be fed at a phase shift of from about 130° to about 200°. In some examples, antiphase (180°) may be specifically avoided as a phase shift between (at least two) adjacent antenna elements 212. Moreover, and as detailed further below with reference to FIG. 3, in some examples a phase change between a first antenna element and an adjacent second antenna element may be different than the phase change between the second antenna element and an adjacent third antenna element.

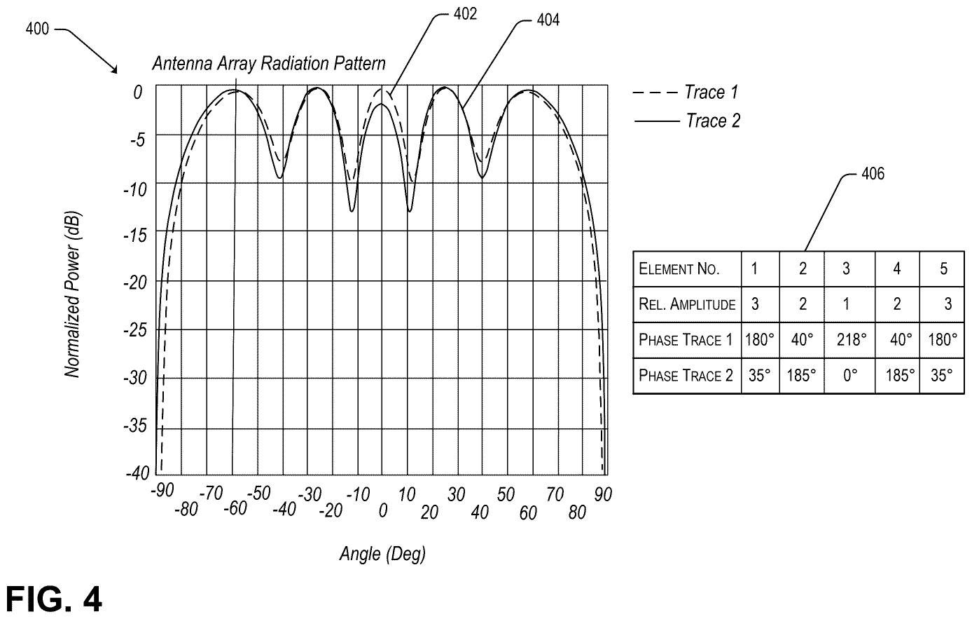

Although the phase shift component 206 is described as shifting the phase of feed to the antenna elements 212, the phase shift component 206 (or a comparable component, for example, as one of the additional component(s) 210) can include functionality to otherwise alter the signals input to the transmit antenna. Without limitation, the amplitude of the input signal may be varied between adjacent antenna elements. In some instances, by making subtle changes to the relative phases and amplitudes, the array radiation pattern can be optimized to reduce the negative impact of deep nulls (null filling) as shown in FIG. 4 and discussed further below.

The processing component(s) 208 can include functionality to receive signals from the receiver antenna 204 and process such signals to identify objects proximate the radar system 108. The processing component(s) 208 can include additional processing functionality associated with the radar system 108. For example, and without limitation, the processing component(s) 208 can include functionality to generate an output signal, e.g., to cause a display or other output device to alert a driver, passenger or other person associated with the radar system 108 of a detected object.

The additional component(s) 210 may be any component(s) necessary for operation of the radar system 108. For example, and without limitation, in some examples the radar system 108 may formed as a stand-alone device, e.g., for securing to the vehicle. Accordingly, the additional component(s) 210 may include a power source and/or one or more conduits or leads. Moreover, the additional component(s) 210 can include one or more communication components, e.g., for transmitting information to and/or receiving information from one or more remote sources. For example, the radar system 108 can receive programming information, updates, and/or the like. In other examples, the radar system 108 may transmit information about a detected object to a display device or other user interface, e.g., to warn of the presence of the object. Other components may also be included, as will be appreciated by those having ordinary skill in the art, with the benefit of this disclosure.

Aspects of this disclosure relate to using multiple strings of patch antennas to improve sensor performance. FIG. 3 is an example antenna system 300, which may correspond to the transmit antenna 202 described above. As illustrated, the antenna system includes a first antenna string 302(1), a second antenna string 302(2), a third antenna string 302(3), a fourth antenna string 302(4), and a fifth antenna string 302(5) (collectively, the antenna strings or strings 302). The antenna strings 302 may correspond to the antenna elements 212 of FIG. 2. Specifically, the strings 302 include a plurality of patches 304, which may be patch antennas. Although 10 patches are shown in each of the strings 302, the strings may include more or fewer patches.

The strings 302 are disposed on a substrate 306, which may be a printed circuit board. The strings 302 generally extend in the z-direction. That is, the patches in each of the strings are spaced vertically from each other. Moreover, the strings 302 are spaced from each other in the x-direction, e.g., horizontally. FIG. 3 also shows feeds or traces 308 associated with the strings 302. The traces 308 are for illustration only.

FIG. 4 is a graph 400 depicting an array radiation pattern for two traces generated by the antenna arrangement illustrated in FIG. 3. More specifically, the graph 400 includes a first trace 402 and a second trace 404. The graph 400 plots normalized power (in dB) and angle (in degrees) for a radar sensor incorporating the antenna system 300 as the transmit antenna 202 for each of the traces. As shown in the table 406 accompanying the graph 400, the phases of the signal applied at the different strings 302 varies for the two traces 402, 404. Specifically, in the table 406 element 1 may correspond to the first antenna string 302(1), element 2 may correspond to the second antenna string 302(2), element 3 may correspond to the third antenna string 302(3), element 4 may correspond to the fourth antenna string 302(4), and element 5 may correspond to the fifth antenna string 302(5). Thus, in the first trace 402, the phase associated with the first string 302(1) is 180° and the phase associated with the second string 302(2) is 40°. The phase difference (140°) between these adjacent strings is near-antiphase, as discussed above. The phase associated with the third string 302(3) is 218°. Accordingly, the phase difference (178°) also is near-antiphase. The phases are symmetrical about the third element, e.g., such that the phase associated with the fourth string 302(4) is the same as the phase associated with the second string 302(2) (e.g., 40°) and the phase associated with the fifth string 302(5) is the same as the phase associated with the first string 302(1) (e.g., 180°). As apparent from the table 406, the phase differences between adjacent strings 302 in the second trace are similarly near-antiphase. In addition, in both of the traces 402, 404 the relative amplitude varies for adjacent strings (or antenna elements).

Returning to the graph 400, the radiation pattern for each of the traces 402, 404 generally include five peaks, one for each of the antenna elements. In examples, the modifications to the relative phases and amplitudes can reduce the negative impact of deep nulls (e.g., via null filling) between the peaks. For a radar sensor, achievable field of view is directly related to the antenna beamwidth, which may be conventionally measured at the −3 dB, −10 dB or −15 dB points. For wide FOV applications the −10 dB (or −15 dB) beamwidths are preferably used to assess performance. For example, these beamwidths may avoid ambiguity with small nulls in the pattern and ensure that the outer most edges of the pattern are being considered. As illustrated from FIG. 4, both traces are within these ranges for substantially all of the 180-degree field of view. As will also be appreciated from the graph 400, by using an odd number of elements in the horizontal direction (five in the example), a null does not occur in the broadside direction (at 0°). For example, 3-string and/or 7-string designs may be suitable. However, this disclosure is not limited to the use of an odd number of antenna elements, because aspects described herein may sufficiently reduce nulls such that a null at the broadside direction may be acceptable.

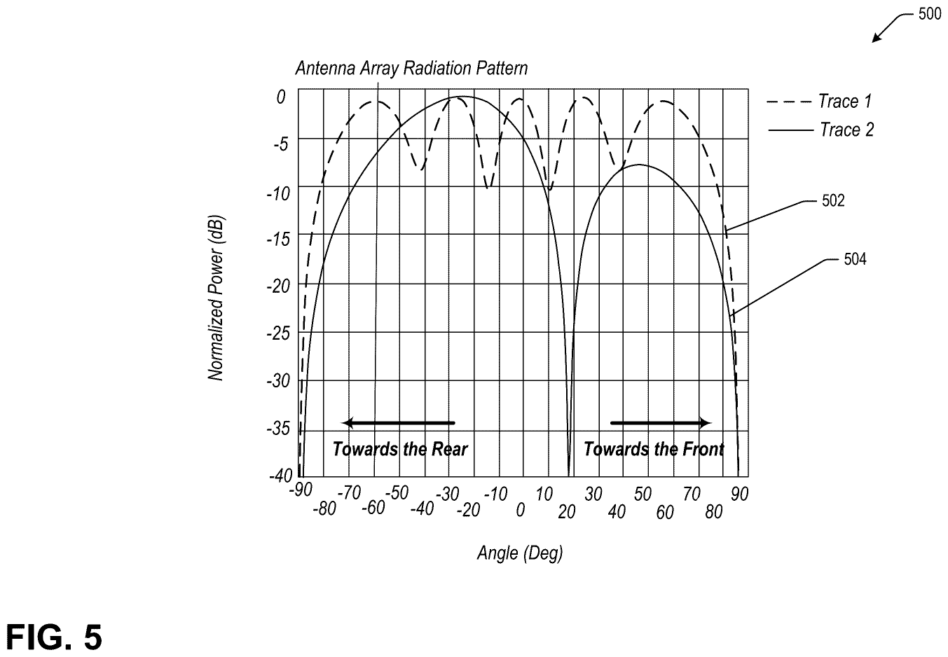

FIG. 5 includes a graph 500 showing normalized angular performance of the 5-up design according to the antenna system 300 (shown by trace 502), compared to a 2-up design (shown by trace 504), generally according to the system described in U.S. Pat. No. 10,042,050, titled “Vehicle Radar System with Blind Spot Detection,” and issued on Aug. 7, 2018. The '050 patent describes a radar system that transmits radiation in a pattern into a region adjacent a vehicle, the pattern comprising a first radiation lobe, a second radiation lobe, and a null region of the pattern between the first lobe and the second lobe directed into the broadside direction. The trace 504 in FIG. 5 illustrates the large null between two main lobes, as disclosed by the '050 patent. In contrast, and as illustrated by the trace 502, the design according to this disclosure has nulls between 5 main lobes, but each of the nulls is substantially smaller than the null associated with the disclosure of the '050 patent.

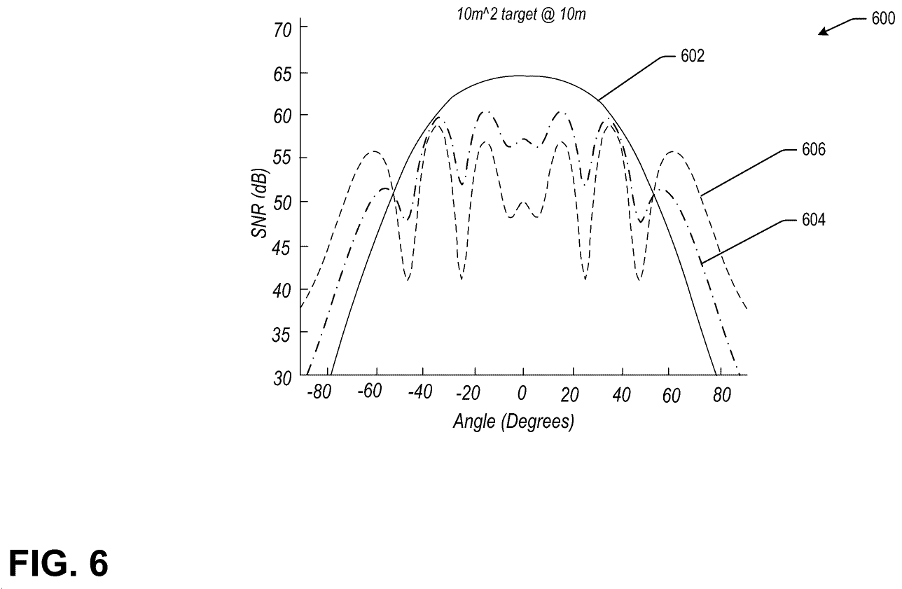

As noted above, additional (or fewer) antenna elements may be used in the transmit antenna 202. FIG. 6 is a graph 600 showing system level improvements in the detectability of an object compared to conventional designs for a transmit antenna with seven antenna elements, e.g., seven strings of patch antennas. Specifically, line 602 corresponds to radiation associated with a transmit antenna design including only a single string, e.g., a 1-up string. Line 604 corresponds to a transmit antenna design that includes seven antenna elements, e.g., seven strings of patch antennas. For example the transmit antenna design associated with the line 604 may be the transmit antenna 202 of FIG. 2, including all of the illustrated antenna elements, e.g., including those shown in dashed lines. The line 604 also corresponds to a receiver antenna design that includes only a single string or antenna element. That is, line 604 is associated with a 7-up design on TX and a 1-up design on RX. Line 606 corresponds to a 7-up design on both TX and RX.

As will be appreciated from the graph 600, the design associated with the line 604 provides a wider field of view than the design associated with the line 602 (e.g., the 1-up design). The design that includes seven elements on both the transmit and receive antennas, represented by the line 606, may improve the very wide angle FOV, e.g., relative to the line 604, but it also introduces deeper nulls and, accordingly, detectability bias in certain directions.

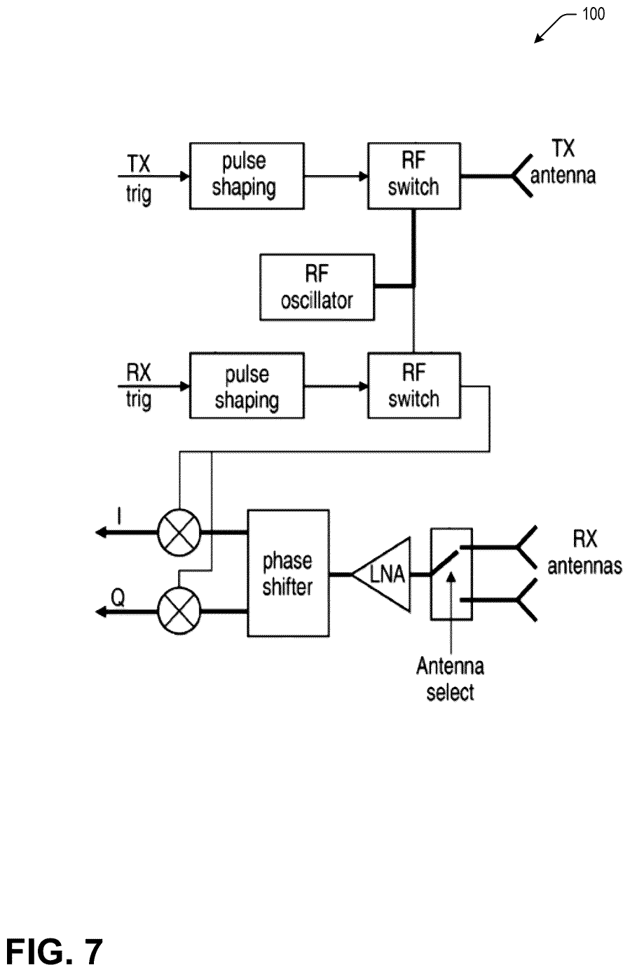

FIG. 7 is a schematic block diagram of transmit and receive circuitry in a radar transceiver or sensor, such as a transceiver or sensor in a radar system for use in a heavy commercial vehicle (HCV) or other vehicle. In FIG. 7, a transmit trigger signal Tx_trig is received by pulse shaping circuitry. The pulse shaping circuitry generates a transmit timing pulse. An RF switch or oscillator generates an RF signal to be transmitted into a region of the environment to be monitored, e.g., a region adjacent to a vehicle. The transmit timing pulse generated by pulse shaping circuitry gates the RF signal to a transmit antenna (TX_antenna), e.g., the transmit antenna 202 discussed above, by enabling the RF switch to selectively pass the pulsed radar signal with the timing of the transmit timing pulse. The transmit antenna transmits the pulsed radar signal to the environment.

FIG. 7 also shows two receive antennas (RX-antennas) that receive radar signals returning from objects illuminated by the transmitted radar signals. An antenna select circuit is used to selectively enable the return radar signals from the antennas such that the return signal from only one of the receive antennas at a time is processed. The selected received signal is amplified by a low-noise amplifier (LNA), and phase shifted as required by a phase shifter before being routed to I and Q mixers. As also illustrated, a receive trigger signal Rx Trig is received by pulse shaping circuitry to generate a receive enabling pulse signal, which is applied to a second RF switch. The RF signal generated by the RF oscillator is gated to the I and Q mixers through the second RF switch, which is selectively enabled to pass the pulsed RF signal by the pulse signal generated by pulse shaping circuitry. This pulsed RF signal mixes with the received amplified and phase-shifted radar signals to generate I and Q IF signals for the returning received radar signals for further processing.

According to aspects of this disclosure, the antenna system may be substantially symmetrical in the azimuthal plane, which may ensure no blind spots and may eliminate the need for different designs for lent-hand or right-hand drive vehicles. Similarly, the antenna systems described herein may be equally effective in either forward or backward direction of travel, which may be particularly useful for bi-directional vehicles, designed to travel in each of two directions.

Moreover, because of the null filling provided by the multiple strings of antennas and/or the driving of those strings, the antenna system may reduce or eliminate the need for careful system wide RF modelling and integration based on vehicle size. For instance, the reduction of nulls may facilitate placement of the antenna system anywhere on the vehicle, without concern for where the nulls of conventional antenna systems may be aligned.

As described, the systems described herein provide a very wide FOV. In examples, a single antenna system can provide sensing along an entire length of a vehicle, even for relatively long vehicles, including tractor trailers or the like. The designs described herein may eliminate the requirement for switching between multiple antenna arrays, reducing system complexity, signal processing time, and/or system memory requirements.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

1. A radar system for monitoring a blind spot of a vehicle, the radar system comprising:
a radar transmitter;
a transmitting antenna coupled to the radar transmitter to transmit radio waves proximate the vehicle, the transmitting antenna comprising a first antenna element, a second antenna element adjacent the first antenna element and extending generally parallel to the first antenna element, and a third antenna element adjacent the second antenna element and extending generally parallel to the second antenna element; and
a receiving antenna configured to receive the radio waves after reflecting off objects in an environment.

2. The radar system of claim 1, wherein
the first antenna element comprises a first string of patch antennas,
the second antenna element comprises a second string of patch antennas, and
the third antenna element comprises a third string of patch antennas.

3. The radar system of claim 2, wherein, when the radar system is coupled to a vehicle, the first string of patch antennas, the second string of patch antennas, and the third string of patch antennas are substantially vertically oriented and are disposed in a substantially vertical plane.

4. The radar system of claim 2, wherein at least one of the first string of patch antennas, the second string of patch antennas, or the third string of patch antennas includes at least eight patches and the at least eight patches are generally aligned.

5. The radar system of claim 1, further comprising a phase shift component coupled to the first antenna element, the second antenna element and the third antenna element, wherein the phase shift component is configured to alter a phase of signals to be transmitted by the first antenna element, the second antenna element, and the third antenna element.

6. The radar system of claim 5, wherein the phase shift component alters the phase of the signals such that at least one of:
a first signal fed to the first antenna element and a second signal fed to the second antenna element have a first phase difference of between about 130° and about 200°; or
the second signal and a third signal fed to the third antenna element have a second phase difference of between about 130° and about 200°.

7. The radar system of claim 6, wherein the first phase difference or the second phase difference is other than 180°.

8. The radar system of claim 1, further comprising a processing component configured to alter an amplitude of signals output via the transmit antenna, wherein the processing component alters the amplitude of at least one of a first signal associated with the first antenna element, a second signal associated with the second antenna element, or a third signal associated with the third antenna element such that the amplitude of the second signal is different from the amplitude of the first signal and the amplitude of the third signal.

9. The radar system of claim 1, wherein the transmitting antenna further comprises at least one additional antennas element.

10. The radar system of claim 9, wherein the transmitting antenna comprises an odd number of antenna elements.

11. The radar system of claim 1, wherein the receiving antenna comprises at least one string of patch antennas.

12. A system comprising:
a vehicle; and
a radar system coupled to a side of the vehicle, the radar system comprising:
a transmitting antenna via which radio waves are transmitted proximate the vehicle, the transmitting antenna comprising a first antenna element, a second antenna element adjacent the first antenna element and extending generally parallel to the first antenna element, and a third antenna element adjacent the second antenna element and extending generally parallel to the second antenna element.

13. The system of claim 12, wherein:
the first antenna element comprises a first string of patch antennas,
the second antenna element comprises a second string of patch antennas, and
the third antenna element comprises a third string of patch antennas.

14. The system of claim 13, wherein the first string of patch antennas, the second string of patch antennas, and the third string of patch antennas are substantially vertically oriented and are disposed in a substantially vertical plane.

15. The system of claim 12, wherein the radar system includes a phase shift component coupled to the first antenna element, the second antenna element, and the third antenna element,
wherein the phase shift component is configured to alter a phase of signals to be transmitted by the first antenna element, the second antenna element, and the third antenna element.

16. A radar system comprising:
a transmitter;
a transmitting antenna coupled to the transmitter to transmit radio waves, the transmitting antenna comprising a plurality of antenna elements, individual antenna elements of the plurality of antenna elements being disposed adjacent and parallel to other of the plurality of antenna elements; and
a receiving antenna configured to receive the radio waves after reflecting off objects in an environment.

17. The radar system of claim 16, wherein the individual of the plurality of antenna elements comprise a plurality of patch elements.

18. The radar system of claim 17, wherein the plurality of patch elements are aligned in a direction parallel to an adjacent one of the plurality of antenna elements.

19. The radar system of claim 16, further comprising a processing component configured to alter an amplitude of signals output via the transmitting antenna, wherein the processing component alters the amplitude of at least one of a first signal associated with a first antenna element of the plurality of antenna elements, a second signal associated with a second antenna element of the plurality of antenna elements, or a third signal associated with a third antenna element of the plurality of antenna elements, such that an amplitude of the second signal is different from an amplitude of the first signal and an amplitude of the third signal.

20. The radar system of claim 16, further comprising a phase shift component coupled to the plurality of antenna elements,
wherein the phase shift component is configured to alter a phase of signals to be transmitted by the first antenna element, the second antenna element, and the third antenna element.
